(19) United States
(12) Patent Application Publication
(10) Pub. No.: US 2014/0333120 A1
(43) Pub. Date: Nov. 13, 2014

(54) MOTOR-REDUCER WITH INTEGRATED BRAKE AND INVERTER FOR DIRECT TRANSMISSION TO THE WHEEL OF AN ELECTRICALLY DRIVEN VEHICLE

(71) Applicant: PMP PRO-MEC S.P.A., Coseano (U) (IT)

(72) Inventor: Luigino Pozzo, Coseano (UD) (IT)

(73) Assignee: PMP PRO-MEC S. P. A., Coseano(UD) (IT)

(21) Appl. No.: 14/370,430

(22) PCT Filed: Dec. 28, 2012
(86) PCT No.: PCT/EP2012/005390

§ 371 Date: Jul. 2, 2014

(30) Foreign Application Priority Data
Jan. 3, 2012 (IT) UD2012A000001

(51) Int. Cl. B60K 7/00; H02K 7/102; H02K 7/116; B60L 11/18

(52) U.S. Cl. CPC B60K 7/0007; B60L 11/18; H02K 7/102; H02K 7/116
USPC 301/6.5

(57) ABSTRACT

Gear-motor with integrated brake for direct drive to the driving-wheel of an electric-traction vehicle where a traction motor is integrated with a gear-reducing device connectable to the driving-wheel of the electric-traction vehicle in correspondence with a hub, where the gear-reducing device is housed into a structural supporting box connectable to the vehicle by means of fixing holes, the traction motor having a supporting casing fixed to the box as a cover, the box and the cover constituting a single structural supporting casing of the gear-motor, where the traction motor is a motor whose transmission shaft is coupled in correspondence of a first pinion of the gear-reducing device or is integral with it and where the motor control inverter is housed in correspondence of the closure head of the motor.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a gear-motor with integrated brake and inverter for direct transmission to the wheel of an electrical traction vehicle according to the characteristics of the pre-characterizing part of claim 1.

The electric-traction vehicle with said gear-motor with integrated brake and inverter is also part of the present invention, according to the characteristics of the pre-characterizing part of claim 22.

2. Description of Related Art Including Information Disclosed Under 37 CFR 1.97 and 37 CFR 1.98

In the field of motion transmission to the driving wheels of vehicles, particularly industrial vehicles, e.g. tractors, forklift trucks, or operating machines, electric or hydraulic motors are normally used.

Motors are commonly associated to a mechanical gear-reducing device that transmits motion to the wheels.

Compact configurations of these gear-reducing devices exist, called axles, which dispense the torque supplied by a single motor to the two wheels by means of a distribution differential group. Other axle configurations provide the use of two motors, one for each wheel.

A second configuration of the traction system provides the use of two completely independent transmissions, one for each driving-wheel, with the aid of a transmission system with incorporated gear-reducing device and brake.

The steering is controlled by an electronic system monitoring signals from the speed sensors on each of the two motors and by a transducer measuring the steering angle.

The current trend aims at using faster and faster, as well as more and more compact, electric motors, in order to reduce the external encumbrance of the gear-motor system and end users require more and more silent machines.

Closest Prior Art to the Invention

Among the prior art techniques, the closest solution to the present invention is the one described in patent WO2007022865, of the same applicant. WO2007022865, describing a gear-motor with integrated brake for direct drive to the wheel of an electric-traction vehicle in which the traction motor is integrated with a reduction transmission connected to the driving-wheel, and in which the traction motor includes a passing driving axle including a pinion on the wheel side which internally gears to the reducer-transmission system integrated with the wheel for the traction motion in a corresponding gear chamber and on the side opposite to the wheel is keyed to a braking system, which is also integrated, and cased with the same assembly, in a corresponding opposite braking chamber forming a detachable motor-brake assembly and in which the transmission reducing group is housed in a structural supporting casing connectable to the vehicle and the motor group has its supporting casing fixed as a cover to the structural supporting casing covering the reducing system and allowing free access after its opening.

Issues of the Prior Art

The prior art techniques providing the use of the axle configuration highly limit designers of industrial vehicles, as the axle size and its encumbrance do not allow a full operational freedom, since the vehicle track, the vehicle frame shape and, in case of forklift trucks, the anchorage system choice of the stanchion, remain fixed.

The traction system configurations providing the use of two completely independent transmissions, one for each driving-wheel, with the aid of a transmission system with integrated gear-reducing device and brake do not limit the designer, showing however issues in terms of high costs in their embodiments and having numerous additional components that need to be duplicated and arranged on the vehicle, this determining an increase of required space for the installation of transmission control components.

Drawbacks of the present state of the art also include:
The need to apply a connection system between the motor shaft and the gear-reducing device input, with consequent increase of the total encumbrance;
alignment difficulty between motor and transmission, which can possibly imply, among other things, the wearing of components and the occurrence of unexpected noise, besides a possible overall system instability;
higher costs, since supporting means suitable for all rotating devices must be provided;
introduction of significant restrictions to the machine design, in case of transmission by means of rigid axles.

The configuration providing two separate transmissions requires the arrangement of a double wiring carrying the power supply and thermal and speed sensor cables to the electronic control junction box.

Even the solution described in WO2007022865 shows drawbacks due to the overall encumbrance of the gear-motor device and to the size of its corresponding components to take into account transmitted power and torque. Additionally, it is necessary to provide the positioning of control devices on the electric-traction vehicle and arrange the corresponding wiring between the control devices and the gear-motor group, with the consequent need to carefully analyse the installation to take into account even the running of all wirings, including power wirings and motor control wirings.

### BRIEF SUMMARY OF THE INVENTION

The aim of this invention is that of implementing a compact and highly reliable integrated gear-motor device with braking function and electronic control, being cost-effective in terms of implementation, installation and maintenance.

### Concept of the Invention

The aim is achieved by means of the characteristics of the main claim. Sub-claims represent advantageous solutions.

### Advantageous Effects of the Invention

The solution in accordance with the present invention, by means of the significant creative contribution the effect of which constitutes an immediate and non-negligible technical progress, shows many advantages.

The system in accordance with the present invention allows providing a motor being highly compact and, as a result, cost-effective and easy to install.

Moreover, the maximum transmission input torque is shown to be almost halved, allowing the use of smaller gears; particularly, the input pinion can be easily produced directly on the motor shaft.

Moreover, the reduction ratio of the gear-reducing device increases proportionally to the speed.

Finally, by arranging an emergency dynamic brake or a parking-brake between motor and gear-reducing device, this will have to develop a little braking torque, with consequent advantages in terms of component sizing, weight, total cost, operational cost-effectiveness and energy saving.

Furthermore, the invention solution considerably reduces the length of power cables that run from the motor control inverter to the motor itself, with significant advantages in terms of installation and maintenance simplicity, as well as in terms of overall costs.

### BRIEF DESCRIPTION OF THE DRAWINGS

The following describes a performable solution with reference to the attached drawings, which shall be considered as a non-limitative example of the present invention in which:

FIG. 1 shows a partially sectional view of the gear-motor with integrated brake and inverter for direct drive to the wheel in conformity with the present invention.

FIG. 2 shows an enlarged partially sectional view of the clutch portion of the gear-motor engine with integrated brake and inverter for direct drive to the wheel in conformity with the present invention.

FIG. 3 shows a three-dimensional view of the central part of the gear-motor with integrated brake and inverter for direct drive to the wheel in conformity with the present invention, illustrating the operation of the integrated brake.

FIG. 4 shows an enlargement of the detail indicated with “A” in FIG. 1.

FIG. 5 shows an enlargement of the detail indicated with “C” in FIG. 3.

FIG. 6 shows an exploded schematic view of the gear-motor with integrated brake and inverter for direct drive to the wheel in conformity with the present invention.

FIG. 7 shows an enlargement of the detail indicated with “B” in FIG. 1.

FIG. 8 shows an enlargement of the detail indicated with “D” in FIG. 7.

### DETAILED DESCRIPTION OF THE INVENTION

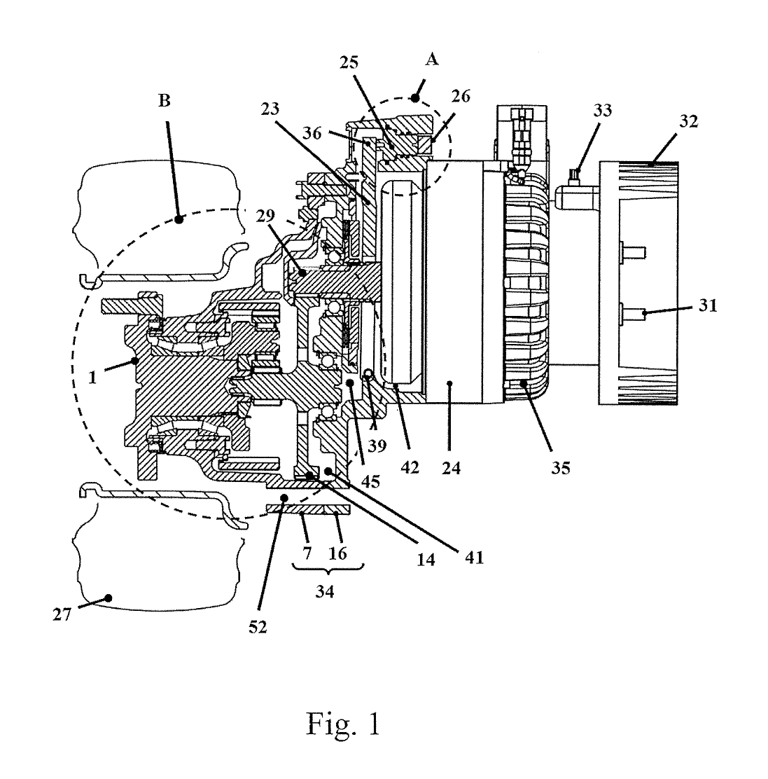

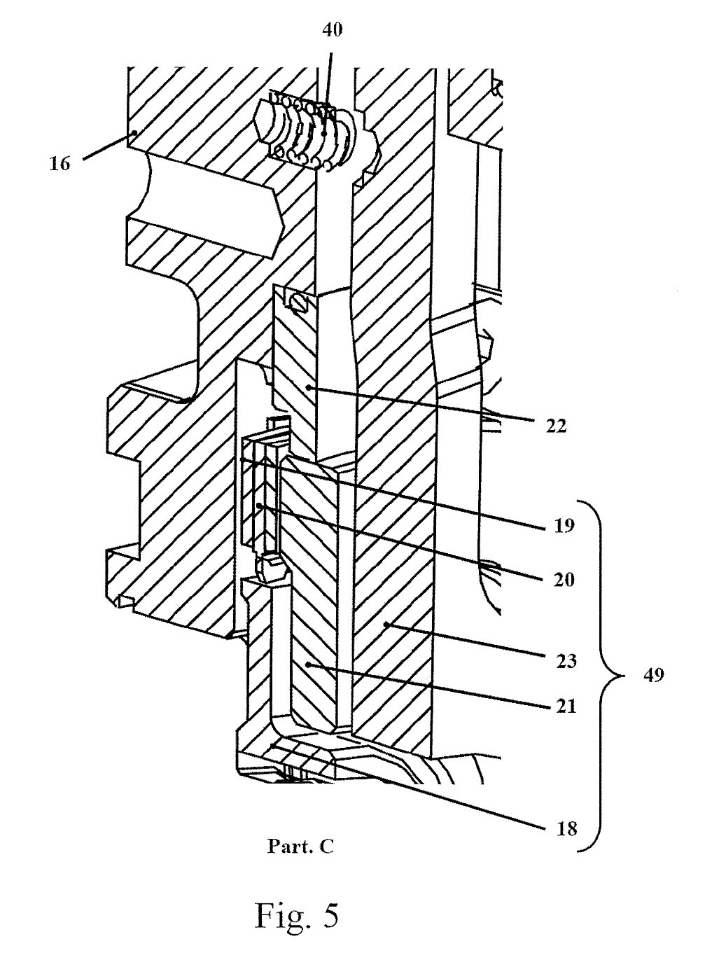

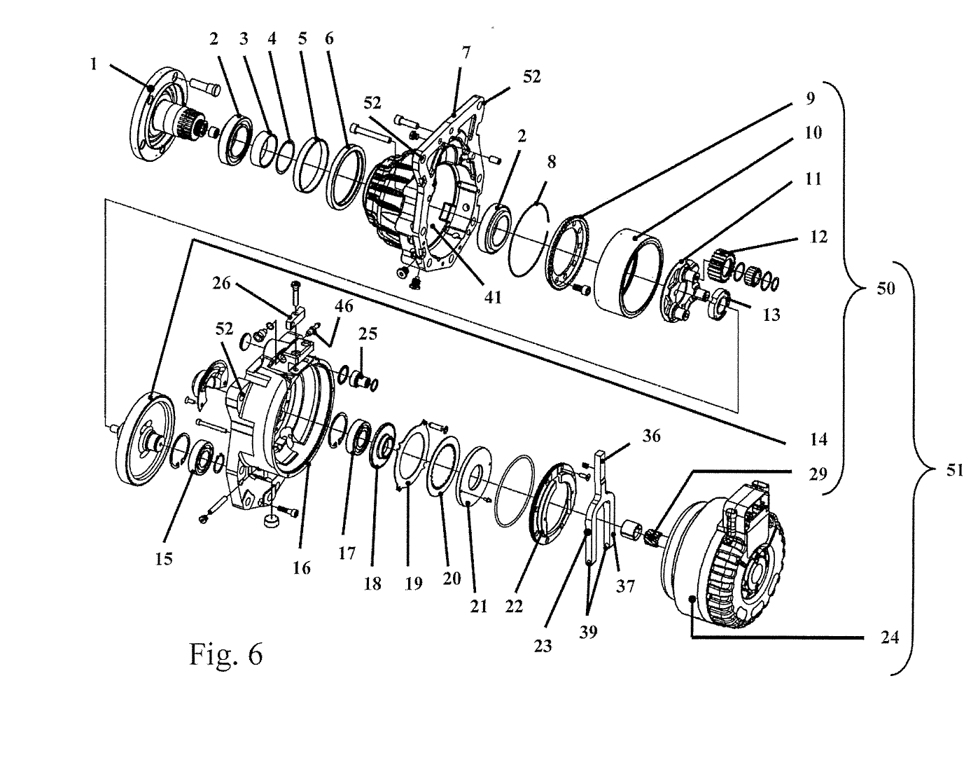

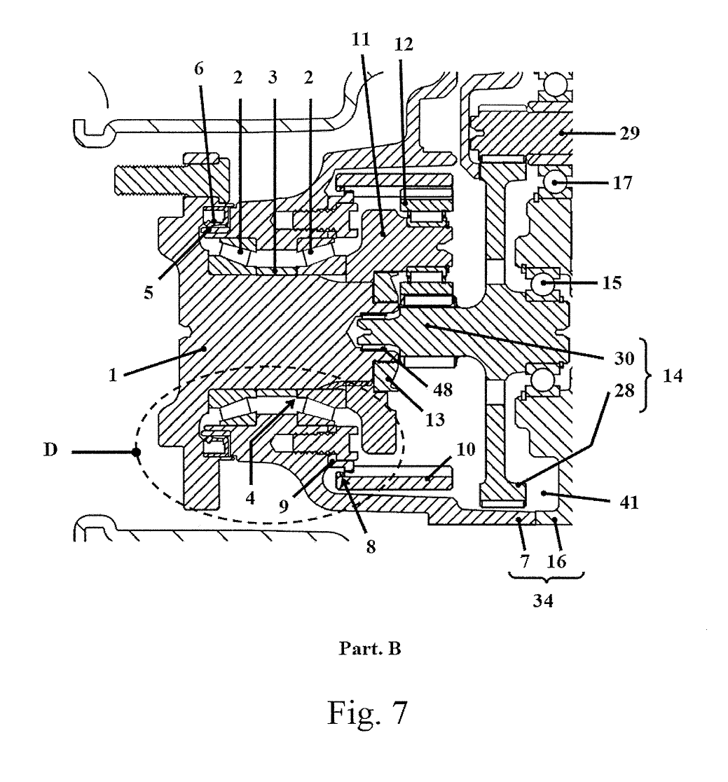

With reference to the figures, the gear-motor with integrated brake and inverter for direct transmission to the wheel according to the present invention allows obtaining a single body consisting (FIG. 1, FIG. 7, FIG. 6, FIG. 5) of the gear-reducing device (50), the motor (24), the brake (49), the inverter (32). A compact and resisting solution is therefore obtained with all the advantages provided by an integrated compact unit. Advantageously, the casing (34) of the gear-motor consists of a first casing being the cover (16) and a second casing being the box (7) forming the entire body or casing (34) containing both the motor (24) and the gear-reducing device (50) becoming an integral part of the transmission. This solution advantageously allows full access to the gear-motor since, by dismantling the casing (34), the gear-motor opens very easily in two parts showing, on one side, the gear-reducing device (50) with full access to its elements from the inside of the vehicle and, on the other side, the motor (24) and the inverter (32) which are also completely and easily accessible since they can be completely detached from the vehicle by simply unscrewing a number of bolts.

Advantageously, all misalignment and coupling issues possibly arising during the installation of an external motor can be therefore avoided. The casing (34) includes one or more chambers (41,42) which may be used as an oil reserve for the braking chamber and/or as a recirculation channel of the oil itself, in case all the reducer oil is to be used for cooling purposes.

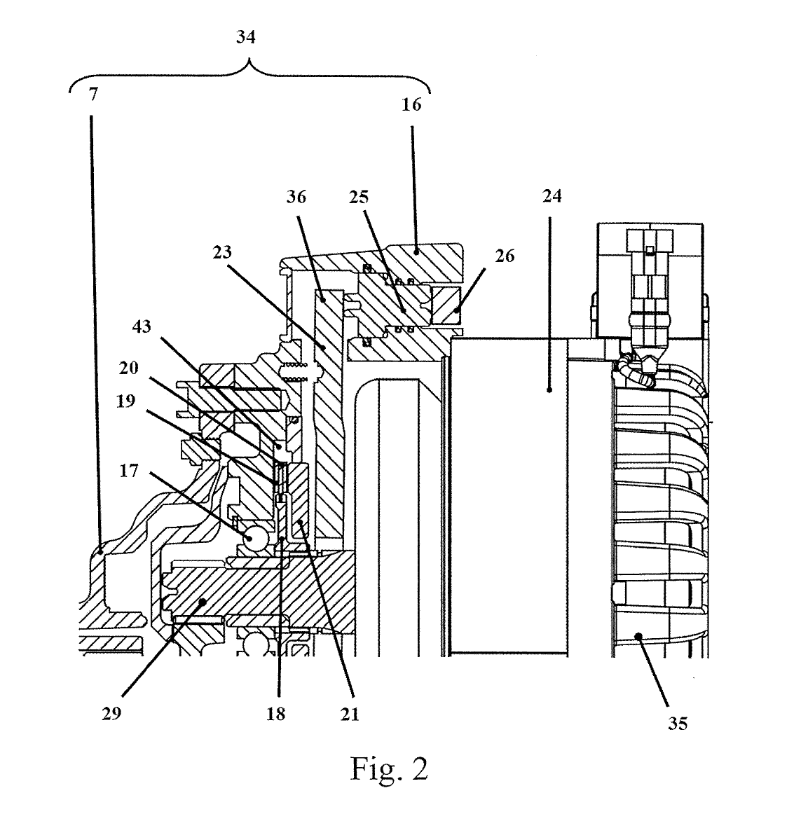

In the solution according to the present invention the motor (24) shaft also directly constitutes the first pinion (29) of the first stage of reduction of the gear-motor. In fact (FIG. 1, FIG. 2) the first pinion (29) or pinion of the first stage of reduction is directly obtained on the shaft of the motor (24). Furthermore, the shaft of the motor (24) also constitutes the connection element for the application of the braking system (49) since (FIG. 5) the friction disc (20) of the brake, or second disc, is connected to the first pinion (29), i.e. to the shaft of the motor (24) itself, by means of a first flange (18) or dragging flange, to perform the braking action directly given by the friction elements on the first pinion (29), namely directly on the shaft of the motor (24). The dragging flange (18) is inwardly radially engaged on the shaft of the motor (24) or on the first pinion of the gear-reducing device (50), in case they are constructed as different elements. The dragging flange (18) is outwardly radially engaged on the friction disc (20). The dragging flange (18) puts in rotation the friction disc (20) at a rotational speed corresponding to the rotational speed of the shaft of the motor (24) or of the first pinion of the gear-reducing device (50).

Consequently the shaft of the motor (24) performs the triple function of:
input gear of the gear-reducing device or first pinion (29);
actual shaft of the motor (24);
application connection of the braking system (49).

This solution produced a very cost-effective and compact transmission able to reach almost absolute constructive precision limits: by obtaining the input gear of the gear-reducing device, namely the first pinion (29), directly on the shaft of the motor (24) the reduction gears can be increased with consequent possibility to increase the rotational speed of the motor thanks to a highly precise construction.

Furthermore, unlike the prior art techniques, the present invention provides the use of a high-speed motor (24), which is made possible by the fact that, thanks to the integration of the motor (24) itself with the gear-reducing device, a single body is formed with a particularly precise coupling. The use of a high-speed motor, for example a motor with maximum speed of about 8000 to 12000 RPM, allows important advantages compared to the prior art techniques:
the motor is particularly compact and therefore cost-effective and light. For example the solution according to the present invention allows the use of high rotational speed and highly compact motors so that, compared to a solution performed with a standard motor, the use of such motor allows a reduction of the encumbrance beyond the frame connection flange towards the inside of the machine by 40%. Moreover, compared to a solution performed with a standard motor, the use of this motor allows working with a double maximum input transmission speed, i.e. with a 100% increase, with all deriving benefits, as explained by the present description;
the maximum input torque is almost halved compared to the configurations of the previous art, allowing the use of smaller gears for the gear-reducing device; particularly the first input pinion (29) of the gear-reducing device can be easily constructed directly on the shaft of the motor (24);
the reduction ratio of the gear-reducing device (50) increases proportionally to the speed;
by applying an emergency dynamic brake (49) or a parking brake between the motor (24) and the gear-reducing device (50), with equal exerted braking action, the brake (49) will have to develop a moderate braking torque.

The gear-motor can provide or not provide the use of oil-immersed motors, thus performing a system in which the oil of the gear-reducing device recirculates through appropriate channels passing through the motor (24) and the brake (49), however without passing close to the motor rotor to perform an overall cooling form of the gear-motor in general: it is therefore possible to avoid the use of sealing gaskets among motor (24), gear-reducing device (50) and brake (49), to the benefit of its mechanical efficiency.

The motor wheel (27) is actuated by the respective hub (1) which is integrated or however integral (FIG. 7) with the spider (11) of the second stage of reduction of the gear-reducing device (50), this second stage of reduction being an epicycloidal reduction stage. In the shown embodiment the spider (11) is fixed (FIG. 6, FIG. 7) to the hub (1) by means of a locking ring (13) screwing on a corresponding threaded portion protruding from the hub (1). Internally and axially to the protrusion comprising the threaded portion, an insertion seat for sliding and support means (48) of the end of the second pinion (30) of a transmission (14) of the gear-motor is obtained on the hub (1). The transmission (14) is supported on the opposite side with respect to the side where the second pinion (30) is obtained, by means (FIG. 6, FIG. 7) of a second bearing (15) or transmission bearing applied on the cover (16). The transmission is thus rotationally supported by the cover (16) and by the hub (1).

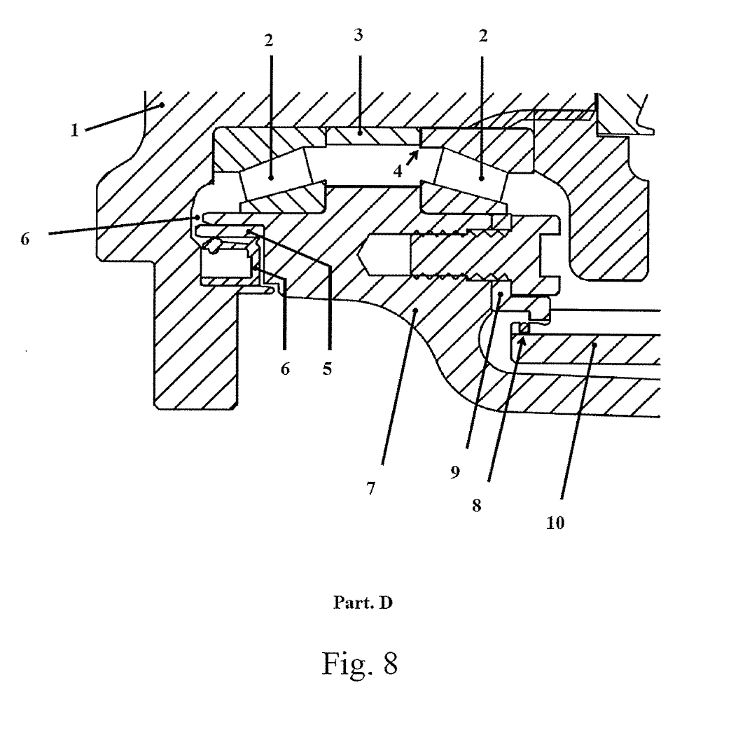

The spider (11) in turn receives the motion by means of satellites (12) of the second stage of reduction that, in the shown embodiment (FIG. 6), are three satellites that plug on three corresponding insertion seats represented on the spider (11) and that are geared on the corresponding first rim (10) or epicycloidal stage rim that is fixed and mounted by means of the first disc (9) or rim-carrier disc, which is screwed on the box (7) of the gear-reducing device (50). The first rim (10) is fixed to the first disc (9) or rim-carrier disc by means of (FIG. 6, FIG. 7, FIG. 8) a fixing ring (8). The satellites (12) receive the motion by means of a transmission (14) which is a single body consisting of and integrating the second pinion (30) or pinion of the epicycloidal stage and the second rim (28) or rim of the first reduction stage. The second toothed rim (28) is directly geared on the first pinion (29) or pinion of the first reduction stage, which, as explained above, is situated directly on the shaft of the motor (24) and is supported in correspondence of the cover (16) by means of a third bearing (17) or first stage pinion bearing. The optimal solution is that the first pinion (29) is obtained directly on the shaft of the motor (24) by means of mechanical work, it is however clear that less preferable solutions could provide that the first pinion (29) is bushed and keyed at the end of the motor, thus making it interchangeable.

All the gears of the gear-reducing device (50) are incorporated in the first chamber (41) or chamber of the gear-reducing device. By means of a connecting channel (45), the first chamber (41) is in flow communication (FIG. 1) with a second chamber (42) working as an additional lubricant container integrated in the fusion of the cover (16) of the casing (34) of the gear-motor constituting the container that, together with the box (7) contains both the motor (24) and the gear-reducing device (50).

The motor (24), in correspondence of the side opposite to the one on which the interface between motor (24) and gear-reducing device (50) is located, is closed (FIG. 1) by a head (35) or closure head that simplifies the access to the motor (24) for inspection, cleaning or maintenance purposes.

As explained above, the casing (34), consisting of cover (16) and box (7), constitutes the container containing both the motor (24) and the gear-reducing device (50) also allowing full access to the gear-motor in that, by dismantling the casing (34) in its two constituent parts, the gear-motor opens very easily in two parts showing the gear-reducing device (50) on one side and the motor (24) on the other side. Consequently, access to the gear-motor is particularly simple and complete in correspondence with all its components with key advantages in terms of supervision and maintenance simplicity.

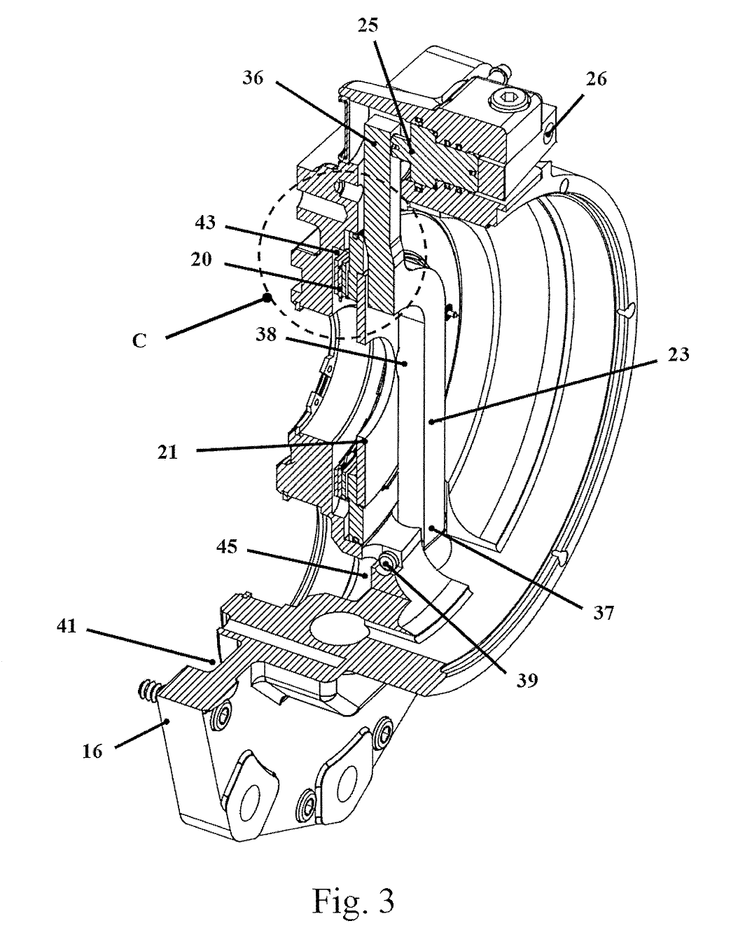

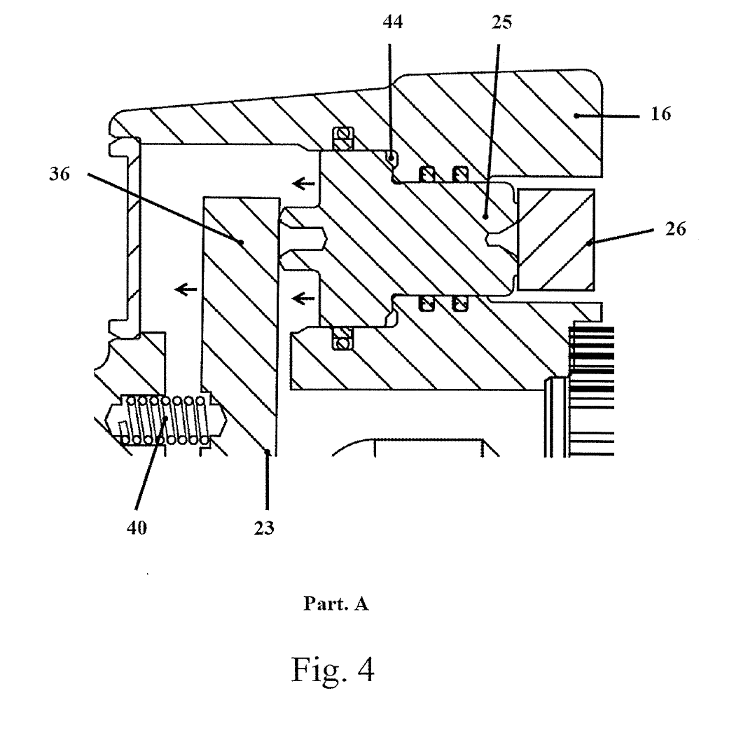

With respect to the prior art techniques, the external brake lever (26) for the mechanical operation of the brake does not act centrally on the axis of the gear-motor (51) in correspondence of the head (35) of the motor (24), but the external brake lever (26) for the mechanical operation of the brake (49) acts (FIG. 1, FIG. 2, FIG. 3, FIG. 4, FIG. 6) in eccentric position in correspondence with a radial end of the gear-motor (51). Furthermore, the friction disc or second disc (20) of the brake is placed in an intermediate position between the gear-reducing device (50) and the motor (24) and is connected to the shaft of the motor, namely to the first pinion (29), in proximity of the coupling with the second rim (28) of the transmission (14) of the second reduction stage. This positioning of the external brake lever (26) and the friction disc or second disc (20) of the brake allows freeing the head (35) of the motor from any operating element. Advantageously, moreover, thanks also to the use of a high-speed motor (24), for example a motor with maximum speed of around 8000 to 12000 RPM, the motor (24) is highly compact.

The characteristics and inventive technical solutions related to the use of a high-speed motor (24), to the arrangement of the braking system (49) in an intermediate position between the motor (24) and the reducer (50), to the use of a single closure casing (34) of the motor (24) and reducer (50) assembly, in addition to the above-mentioned advantages in terms of compactness and lightness of the gear-motor (51) in general together, also allows the housing (FIG. 1) of the inverter (32) controlling the motor (24) directly in correspondence of the closing head (35) of the motor (24). This solution would not be possible in the systems of the prior art since the overall encumbrance of the motor and the gear-reducing device would be too high and the addition of the inverter on the closure head (35) of the motor (24) would imply an additional encumbrance increase that would make the installation of the gear-motor and the inverter highly difficult. On the contrary, the inventive solution allows, with an even smaller encumbrance than the one common in the prior art, to arrange the inverter (32) controlling the motor (24) directly in correspondence of the closure head (35) of the motor (24) in order to further facilitate both installation on the electric-traction vehicle, and maintenance operations. The advantages that can be obtained with this configuration are important because the length of the power cables that run from the motor control inverter (32) to the motor (24) itself is considerably reduced with important advantages in terms of installation and maintenance simplicity, immunity to electrical interference, reduction of emitted electrical interference. Moreover, overall installation costs are also reduced because it is sufficient to connect the feeding cables to the inverter by means of the feeding connectors (31) and the control cable by means of the data line connector (33).

All this involves important benefits and obtains a gear-motor (51) assembly with compact, solid, cost-effective, and light integrated inverter (32), with benefits also in terms of overall consumption of the controlled electric-traction vehicle.

The braking system (49) consists of the friction disc (20) or second disc, the action of which is controlled (FIG. 1, FIG. 2, FIG. 3, FIG. 4) by an internal brake lever (23) which is placed inside the gear-motor (51) in an intermediate position between the motor (24) and the gear-reducing device (50), within a third chamber (43) constituting the disc brake chamber. The internal brake lever (23) is hinged (FIG. 1, FIG. 3) in correspondence of a first end (36) on the fulcrum point (39) and is controlled in a pushing action in correspondence of a second end (37) opposite to the first end (36) with respect to the longitudinal development of the internal brake lever (23) in general. The pushing action applied to the internal brake lever (23) involves (FIG. 3) the application of a pushing force on the force application point (38) which is approximately in an intermediate position between the first end (36) and the second end (37) of the internal brake lever (23). The pushing action applied by the internal brake lever (23) in correspondence of the force application point (38) causes (FIG. 5) the progress of the third disc (21) or pressure disc with the clamping of the friction disc (20) between this third disc (21) or pressure disc and the counter disc (19). The third disc (21) or pressure disc is supported by means of a second flange (22) or pressure disc supporting flange fixed on the cover (16) in correspondence of the cover side (16) on which the motor (24) is engaged, namely on the opposite side of the cover (16) with respect to the fixing side of the box (7) housing the gear-reducing device (50). Consequently, the braking system (49) consists of an oil-immersed disc brake with hydraulic activation and a mechanical lever. An elastic means (40), being in the shown embodiment is a spring placed between the cover (16) and the internal brake lever (23), exerts its reaction force by pushing the internal brake lever (23) in the opposite direction with respect to the pushing direction exerted by the piston (25) to bring the braking system (49) back in its non-braking condition.

The hydraulic activation occurs (FIG. 4) by injecting oil in an injection chamber (44) by means (FIG. 6) of a connection (46) placed on the cover (16). The oil injection in the injection chamber (44) involves the pushing of a piston (25) exerting the necessary pushing force in correspondence of the second end (37) of the internal brake lever (23).

Alternatively, the piston (25) can be brought in pushing condition even by acting on an external brake lever (26) which exerts its own action directly on the piston (25) for the control of the braking action, thus performing a mechanical drive.

Advantageously, the use of a high-speed motor, indicatively 8000 to 12000 RPM, allows the reduction, down to almost a half, of the input maximum torque to the transmission, allowing the use of smaller gears. Consequently higher reduction ratios can be used. Approximately, while the prior art required the use of gear-reducing devices with a reduction ratio of about 20/30, the inventive system allows the use of a reduction ratio of about 50/60.

Advantageously the availability of a particularly compact gear-motor assembly (51) with integrated inverter (32) also allows having configurations of electric-traction vehicles with a complete group for each traction wheel allowing the obtainment of single controls on each of the driving wheels, each equipped with its own gear-motor (51) with integrated inverter (32). Alternatively, the inventive solution can be also applied in correspondence with a single traction wheel, for example, but without limitation within the aim of the present invention, in case of three-wheel electric-traction vehicles.

Without limitation within the aim of the present invention, examples of electric-traction vehicles on which the gear-motor (51) with integrated inverter (32) according to the present invention can be applied are work vehicles, tractors, forklift trucks.

The hub (1) of the wheel (27) is supported (FIG. 6, FIG. 7, FIG. 8) within the box (7) of the gear-motor (51) by means of a pair of first bearings (2) with interposed spacer (3). Possible adjusting shims (4) interposed between the first bearings (2) and the spacer (3) further allow the correction and adjustment of the hub (1) fixing. In less preferred solutions of the present invention, the hub (1) of the wheel (27) can also be supported by a single bearing.

The existing spans (47) (FIG. 6, FIG. 8) between the hub (1) and the box (7) are closed by means of a gasket (6) coupling with a corresponding gasket track (5) in order to perform the previously explained sealing condition, with the further advantage of avoiding any possible dirt infiltration.

Basically, the present invention relates to a gear-motor (51) with integrated brake (49) for direct transmission to the motor wheel (27) of an electric-traction vehicle in which the traction motor (24) is integrated into a gear-reducing device (50) connectable to the driving wheel (27) of the electrical traction vehicle in correspondence of a hub (1), in which the gear-reducing device (50) is housed into a structural supporting box (7) connectable to the electric-traction vehicle by means of fixing holes (52). The traction motor (24) has a support casing that can be fixed as a cover (16) to the box (7), the box (7) and the cover (16) constituting a single structural support casing (34) of the gear-motor (51), the cover (16) covering and closing the gear-reducing device (50) within the box (7), the opening of the cover (16) allowing free access to the gear-reducing device (50) on one side and to the motor (51) on the opposite side. The traction motor (24) is a compact high speed motor (24) with maximum speed of about 8000 to 12000 RPM, whose transmission shaft is coupled in correspondence of the first pinion of the gear-reducing device (50) or is integral with the first pinion of the gear-reducing device (50). Preferably the driving and control inverter (32) of the motor (24) is housed in correspondence with the closing head (35) of the motor (24), the driving and control wiring between the inverter (32) and the motor (24) having a minimum length given by the small distance between the motor (24) and the inverter (32) housed in correspondence of the closing head (35) of the motor (24), the driving and control wiring of the gear-motor (51) by means of controls coming from the electrical traction vehicle comprising power supply cables of the inverter (32) connected to feeding connectors (31) and a control cable connected to a data line connector (33) of the inverter (32).

The gear-reducing device (50) is preferably a two-stage gear-reducing device of which a first stage is coupled to the shaft of the motor (24) and a second stage is an epicycloidal stage coupled to the hub (1).

Finally, the present invention also relates to an electrical traction vehicle including at least one gear-motor (51) according to the present invention for direct transmission to the motor wheel (27) of the electric-traction vehicle.

The description of the present invention, in its preferred embodiment, makes reference to the enclosed figures, it is however obvious that many possible modifications, changes and variants will be immediately clear to those skilled in the art in light of the previous description. Therefore, it should be noted that the previous description is not limitative of the invention, but includes all modifications, changes and variants in accordance with the appended claims.

### EMPLOYED NOMENCLATURE

The following nomenclature has been used with reference to the reference numbers indicated in the enclosed figures:

1. Wheel hub

2. First bearing or bearing of the wheel hub

3. Spacer

4. Adjusting shim

5. Track for the gasket

6. Gasket

7. Box

8. Locking ring of the rim

9. First disc or rim-carrier disc

10. First rim or rim of the epicycloidal stage

11. Spider

12. Satellite

13. Locking ring

14. Transmission

15. Second bearing or transmission bearing

16. Supporting casing or cover

17. Third bearing or bearing of the first stage pinion

18. First flange or dragging flange

19. Counter disc

20. Second disc or friction disc

21. Third disc or pressure disc

22. Second flange or pressure disc supporting flange

23. Internal brake lever

24. Motor

25. Piston

26. External brake lever

27. Wheel

28. Second rim or rim of the first reduction stage

29. First pinion or pinion of the first reduction stage

30. Second pinion or pinion of the epicycloidal stage

31. Inverter feeding connector

32. Inverter

33. Inverter data line connector

34. Casing

35. Head or motor closing head

36. First end

37. Second end

38. Force application point

39. Fulcrum

40. Elastic means

41. First chamber or chamber of the gear-reducing device

42. Second chamber or additional container integrated in the fusion

43. Third chamber or chamber of the disc brake

44. Injection chamber

45. Connecting channel

46. Connection

47. Span

48. Sliding and support means

49. Brake or braking system

50. Gear-reducing device

51. Gear-motor

52. Fixing holes

1. Gear-motor with integrated brake for direct drive to the driving-wheel of an electric-traction vehicle where a traction motor is integrated with a gear-reducing device connectable to said driving-wheel of said electric-traction vehicle in correspondence with a hub, where said gear-reducing device is housed into a structural supporting box connectable to said electric-traction vehicle by means of fixing holes, said traction motor having its own supporting shell which is fixed as a cover to said box, said box and said cover constituting a single structural supporting casing of said gear-motor, said cover covering and encompassing said gear-reducing device within said box, the opening of said cover allowing the free access to said gear-reducing device on one side and to said motor at the opposite side characterised in that said traction motor is a motor whose transmission shaft is coupled in correspondence of a first pinion of said gear-reducing device or it is integral with said first pinion of said gear-reducing device and further characterised in that it includes an inverter intended to control said motor, said inverter being housed at the closing head of said motor, the driving and control wiring between said inverter and said motor having a minimum length which is given by the small distance between said motor and said inverter which is housed at the closing head of said motor, the driving and control wiring of said gear-motor by means of controls coming from said electric-traction vehicle comprising power supply cables for said inverter connected to feeding connectors and a control cable connected to a data line connector of said inverter.

2. Gear-motor according to claim 1, wherein said traction motor is a motor with maximum speed between 8000 and 12000 RPM.

3. Gear-motor according to claim 1, wherein said brake is located in between said traction motor and said gear-reducing device.

4. Gear-motor according to claim 1, wherein said brake comprises an oil-immersed disc brake with hydraulic activation and with activation by means of a mechanical lever.

5. Gear-motor according to claim 1, wherein said brake includes a friction disc whose braking action is controlled by an internal brake lever which is internally located with respect to said gear-motor in between said motor and said gear-reducing device, within a third chamber constituting the chamber of said brake, said internal brake lever being hinged in correspondence of a first end on a fulcrum point and being controlled in a pushing action in correspondence of a second end which is an opposite end with respect to said first end with respect to the longitudinal development of said internal brake lever.

6. Gear-motor according to claim 5, wherein the pushing action applied to said internal brake lever is applied by means of a hydraulic activation piston, the hydraulic activation occurring by injecting oil in an injection chamber by means of a connection which is placed on said cover, the oil injection into said injection chamber involving the pushing of said piston which applies a corresponding pushing force in correspondence with said second end of said internal brake lever.

7. Gear-motor according to claim 6, wherein the pushing action applied to said internal brake lever is applied by means of an external brake lever which applies its action in order to control the braking action by means of a mechanical control.

8. Gear-motor according to claim 7, wherein said external brake lever applies its control action of the braking action on said internal brake lever by means of said piston, the pushing force applied by said external brake lever being applied on the opposite end of said piston with respect to the end of said piston which pushes on said internal brake lever, said piston transferring said force which is applied on said external brake lever to said internal brake lever controlling the braking action.

9. Gear-motor according to claim 5, wherein the pushing action applied to said internal brake lever involves the application of a pushing force on an application point of the force which is essentially in between said first end and said second end of said internal brake lever, the pushing action applied by said internal brake lever in correspondence with said application point of the force causing the advancement of a third disc or pressure disc causing the clamping of said friction disc between said third disc or pressure disc and a counter disc.

10. Gear-motor according to claim 9, wherein said third disc or pressure disc is supported by means of a second flange or support flange of the pressure disc which is fixed on said cover in correspondence of the side of said cover on which said motor engages, namely on the opposite side of said cover with respect to the side intended to be fixed on said box for housing said gear-reducing device.

11. Gear-motor according to claim 5, wherein said fulcrum point of said internal brake lever is located on said cover, said cover comprising an insertion seat for an elastic means applying a reaction force pushing said internal brake lever in the opposite direction with respect to the pushing direction applied by said piston

12. Gear-motor according to claim 5, wherein the braking action of said brake is applied in correspondence with said shaft of said motor by means of a dragging flange which is radially inwardly engaged to said shaft of said motor or on said first pinion of said gear-reducing device.

13. Gear-motor according to claim 12, wherein said dragging flange is radially outwardly engaged to said friction disc, said dragging flange putting in rotation said friction disc at a rotational speed corresponding to the rotation speed of said shaft of said motor or of said first pinion of said gear-reducing device.

14. Gear-motor according to claim 1, wherein said first pinion or pinion of the first stage of reduction of said gear-reducing device is directly obtained on said shaft of said motor, said shaft of said motor being mechanically machined to obtain the connection gear of said first pinion.

15. Gear-motor according to claim 1, wherein said first pinion is coupled to said shaft of said motor by means of a buckle and by keying in correspondence with the end of said shaft of said motor.

16. Gear-motor according to claim 1, wherein said gear-reducing device is a gear-reducing device with two stages of which a first stage is coupled with said shaft of said motor and a second stage is an epicycloidal stage coupled to said hub.

17. Gear-motor according to claim 16, wherein said hub is integrated and integral with the spider of a second stage of reduction of said gear-reducing device, said spider being fixed to said hub by means of a locking ring which is screwed on a corresponding threaded portion protruding from said hub, internally and axially with respect to said protrusion an insertion seat being obtained for sliding and supporting means of the end of a second pinion of a transmission of the gear-motor, said transmission being supported at the opposite side with respect to the side where said second pinion is obtained, by means of a second bearing or bearing of the transmission which is applied on said cover, said transmission being rotationally supported by said cover and by said hub.

18. Gear-motor according to claim 17, wherein said spider (receives the motion by means of satellites which plug on corresponding insertion seats of said spider and which are engaged on a first rim or rim of the epicycloidal stage which is fixed and which is mounted by means of a first disc or rim-carrier disc, which is screwed on said box of said gear-reducing device.

19. Gear-motor according to claim 18, wherein said spider includes three insertion seats for three corresponding satellites.

20. Gear-motor according to claim 18, wherein said satellites receive the motion by means of said transmission which is a single body comprising of and integrating said second pinion or pinion of the epicycloidal stage and a second rim or rim of the first reduction stage, said second rim being a toothed rim which is directly engaged to said first pinion of said gear-reducing device.

21. Gear-motor according to claim 1, wherein the gears of said gear-reducing device are housed in a first chamber or chamber of the gear-reducing device which is obtained within said box, and wherein that said motor is housed in a second chamber obtained within said cover, said first chamber being in flow communication with said second chamber by means of a connecting channel, said second chamber constituting an additional container of the lubricant of said gear-reducing device.

22. Electric-traction vehicle characterised in that it includes at least one gear-motor according to claim 1 for direct drive to said driving-wheel of said electric-traction vehicle.
